(19) United States
(12) Patent Application Publication
(10) Pub. No.: US 2014/0120273 A1
(43) Pub. Date: May 1, 2014

(54) METHOD FOR PREVENTING GALVANIC AND CHEMICAL CORROSION IN EMBLEMS CONTAINING SECOND SURFACE DECORATION AND METALLIZATION AND METHOD OF MAKING AND USING THE SAME

(71) Applicant: GM GLOBAL TECHNOLOGY OPERATIONS LLC, Detroit, MI (US)

(72) Inventors: Joel Colombo, Howell, MI (US); Charles K. Buehler, Lansing, MI (US); Catherine A. Ostrander, Grand Blanc, MI (US); Michael P. Balogh, Novi, MI (US); Kitty L. Gong, Macomb, MI (US); Kevin L. Lid, Lake Orion, MI (US)

(73) Assignee: GM GLOBAL TECHNOLOGY OPERATIONS LLC, Detroit, MI (US)

(21) Appl. No.: 13/660,588

(22) Filed: Oct. 25, 2012

(51) Int. Cl. B32B 3/00; B32B 15/04; B05D 1/36; B32B 27/36; B60R 13/00; B32B 33/00; B32B 7/12

(52) U.S. Cl. 428/31; 428/201; 428/457; 428/76; 428/412; 428/336; 427/404

(57) ABSTRACT

A display emblem may comprise a metallized layer, a decoration layer, and at least one moisture impermeable layer.

### TECHNICAL FIELD

The field to which this disclosure generally relates includes display emblems, and methods of making and using the same, and in particular to moisture impermeable layers within a display emblem.

### BACKGROUND

Leinweber et al, U.S. Pat. No. 6,184,842, issued Feb. 6, 2012, in the Abstract, States: “A radome for a range warning radar system has metallic structures, such as a manufacture's symbol or a characteristic structure, formed therein. Surfaces of the characteristic structure are coated with a metallic or metallically glossy layer which is transparent to electromagnetic radiation of the radar system and reflect visible light.”

### SUMMARY OF SELECT ILLUSTRATIVE VARIATIONS OF THE INVENTION

One variation of the invention may include a transparent display emblem comprising of a plurality of layers. The plurality of layers may comprise a lens layer, a decoration layer, an adhesion layer, a metallized layer, and a backing.

Another variation of the invention may include a display emblem comprising of a plurality of layers. The plurality of layers may further comprise a lens layer, a decoration layer, a moisture impermeable first adhesion layer, and a metallized layer.

Another variation of the invention may include a second moisture impermeable adhesion layer underlying the metallized layer.

Another variation of the invention may provide for a method of preventing galvanic and chemical corrosion within a radar transparent display emblem comprising of a plurality of layers. The plurality of layers may further comprise a lens layer, a decoration layer, a first moisture impermeable adhesion layer, a metallized layer, and a second moisture impermeable backing. In other variation the first moisture impermeable adhesion layer and/or the second moisture impermeable backing may also by electrically insulating.

Other variations of the invention will become apparent from the detailed description provided hereinafter. It should be understood that the detailed description and specific examples, while disclosing illustrative variations of the invention, are intended for purposes of illustration only and are not intended to limit the scope of the invention.

### BRIEF DESCRIPTION OF THE DRAWINGS

Illustrative variations of the invention will become more fully understood from the following brief description of the drawings.

FIG. 1 depicts an illustrative variation of a layered construction of a display emblem having permeable layers.

FIG. 2 depicts an illustrative variation of a layered construction of a display emblem having at least one moisture impermeable layer.

FIG. 3 depicts another illustrative variation of a layered construction of a display emblem having at least one moisture impermeable layer.

FIG. 4 depicts another illustrative variation of a vehicle having a display emblem and an optional radar device.

### DETAILED DESCRIPTION OF SELECT ILLUSTRATIVE VARIATIONS

The following detailed description of select variations is merely illustrative in nature and is in no way intended to limit the claimed inventions, applications, or uses.

FIG. 1 depicts an illustrative variation of a display emblem having permeable layers. The display emblem 10 may comprise a plurality of layers further comprising a lens 12, a decoration layer 14, an adhesion layer 16, a metallized layer 18, and a backing 20.

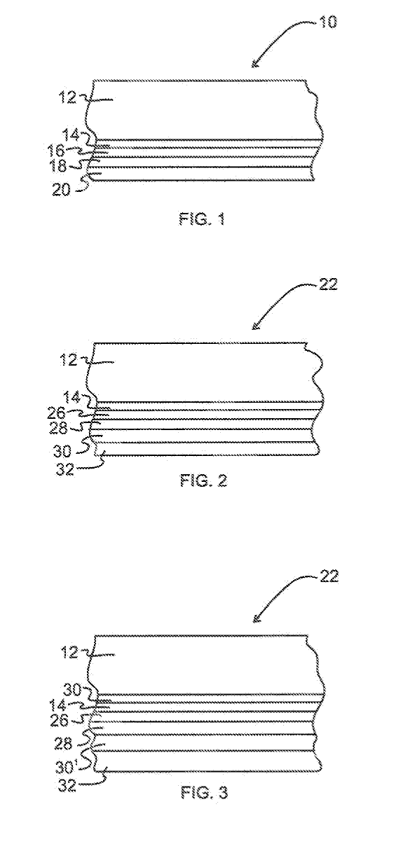

FIG. 2 depicts an illustrative variation of a display emblem having at least one moisture impermeable layer. The display emblem 22 may be constructed and arranged to prevent galvanic and/or chemical corrosions of a metallization and/or pigmented component or elements thereof. In select illustrative variations, the display emblem may be used in a vehicle with or without a radar device. One illustrative variation may include a radar transparent display emblem 22 which may include a plurality of layers including a lens 12, a decoration layer 14, a first moisture impermeable layer 26, a metallized layer 28, and a backing layer 32.

FIG. 3 depicts an illustrative variation of a display emblem having at least one moisture impermeable layer. The display emblem 22 may be constructed and arranged to prevent galvanic and/or chemical corrosions of a metallization and/or pigmented component or elements thereof. In select illustrative variations, the display emblem may be used in a vehicle with or without a radar device. One illustrative variation may include a radar transparent display emblem 22 which may include a plurality of layers including a lens 12, a first moisture impermeable layer 30, a decoration layer 14, a second moisture impermeable layer 26, a metallized layer 28, an optional third moisture impermeable layer 30′, and a backing layer 32.

In other select variations illustratively depicted in FIG. 3, the decorative layer 14 may be encapsulated by a second moisture impermeable layer 26 underlying the decorative layer 14 and a first moisture impermeable layer 30 overlying the decorative layer 14. In another variation, the decorative layer 14 may be encapsulated by a first impermeable layer 30 overlying the same and at least one of another (or third) moisture impermeable layer 30′ underlying the decorative layer 14 or a moisture impermeable backing layer 32. In other variations, at least two or three or four moisture impermeable layers 26, 30, 30′, 32, may be used to encapsulate at least one of the decorative layer 14 or metallized layer 28.

In other select variations illustratively depicted in FIG. 3, the metallized layer 28 may be encapsulated by a second moisture impermeable layer 26 overlying the metallized layer 28 and a third moisture impermeable layer 30′ underlying the metallized layer 28. In another variation, the metallized layer 28 may be encapsulated by a second impermeable layer 26 overlying the same and at least one of another (or third) moisture impermeable layer 30′ underlying the metallized layer 28 or a moisture impermeable backing layer 32. In other variations, at least two or three or four moisture impermeable layers 26, 30, 30′, 32, may be used to encapsulate at least one of the decorative layer 14 or metallized layer 28.

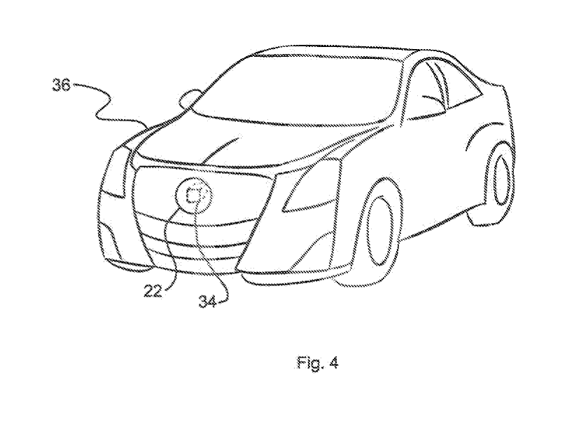

FIG. 4 depicts an illustrative variation of a display emblem having at least one moisture impermeable layer. The display emblem 22 may be constructed and arranged to prevent galvanic and/or chemical corrosions of a metallization and/or pigmented component or elements thereof. In select illustrative variations, the display emblem 22 may be used in a vehicle 36 with or without a radar device 34.

The invention includes the discovery that at least one of the lens 12, adhesive layer 16, or backing 20 shown in FIG. 1 may be moisture permeable, allowing water from the environment to enter the display emblem and make contact with the decoration layer 14 and metallized layer 18. Due to different metals used in the pigment of the decoration layer 14 and the metallized layer 18, galvanic corrosion may occur damaging the decorative layer 14 or metallized layer 18. Further, the moisture (water) may react with halogenated compound(s) in the pigment to produce and acid such as HC1 and/or HF, resulting in chemical corrosions and damage of at least one of the decorative layer 14 or metallized layer 18. Encapsulating at least one of the decorative layer 14 or metallized layer 18 in moisture impermeable layers prevents moisture (water) from reacting with elements in the pigments of the decorative layer 14 or metallized layer 18, and isolates the decorative layer 14 from the metallized layer 18 preventing water from making a connection between the two layers and causing galvanic corrosion. In one variation, a signal moisture (water) impermeable layer may be interposed between the decorative layer 14 and the metallization layer 18 thereby isolating the layer and preventing galvanic corrosion or chemical corrosion from damaging the decorative layer 14 and the metallization layer 18.

In one variation, optionally a second layer 30 may be interposed between the metallized layer 28 and the backing layer 32. In one variation, at least one of the second layer 30 or the backing layer 32 is moisture impermeable.

In select variations, the display emblem 22 may include a logo, badge, symbol, brand, trademark, insignia, marker, or other image or text suitable for displaying a particular brand, feature, or company. For instance, but not limited to, the display emblem 22 may include a brand identification badge on the exterior of an automobile or an identification marker of a particular feature or capabilities of automobiles. Alternatively, the display emblem 22 may comprise an identification symbol or marker on the exterior or interior of aerospace or nautical vehicles.

In select variations, the lens 12 may include a transparent, translucent, or opaque layer, which may include a polycarbonate based material. In one variation, the lens 12 may be radar transparent. The lens 12 may function to enhance or alter the perspective or appearance of an underlying layer or layers, e.g., the lens 12 may be perspective correcting.

In select variations, the decoration layer 14 may include a layer of decorative paint or pigment or other similar means for displaying an emblem, logo, or image and may be transparent, translucent, or opaque. In one variation, the decorative paint may include metallic elements and, optionally, non-metallic elements, such as but not limited to, copper, iron, or the like. In one variation, at least one of the metallized layer 28 or backing layer 32 is electrically insulating. In one variation, the metallized layer 28 is encapsulated in moisture impermeable layers 26 and 30 or 32.

In select variations, the adhesion layer 14 may be a layer including a clear coat acrylic adhesion promoter. In one variation, the adhesion layer 14 may be of a type known as an “adpro” layer. In one variation, the adhesion layer 14 may function as an intermediate layer to aid in adhesion between multiple substrates or layers. In one variation, the adhesion layer 14 may be a non-continuous layer. In one variation, the adhesion layer 14 may have a thickness ranging from about 5 micrometers to about 7 micrometers. In one variation, the adhesion layer 14 may be 5 micrometers thick or thicker. In one variation, the adhesion layer 14 may be moisture impermeable, and optionally may be electrically insulating. In one variation, the adhesion layer 14 may be deposited or applied to an underlying substrate or layer through methods such as, but not limited to, spin-coating, spraying, contact printing, painting, coating, thin-film deposition, thermal spraying, or vapor deposition.

In select variations, the metallized layer 26 may include a coating, plating, or substrate including metallic elements. In one variation, the metallized layer 26 may be deposited on an underlying substrate which may be metallic or non-metallic. In one variation, the metallized layer may include the metallic element indium. In one variation, the metallized layer 26 may be deposited by methods familiar in the art, such as, but not limited to, spraying, painting, coating, thin-film deposition, electroplating, electro-less plating, thermal spraying, metallizing, vapor deposition, or vacuum metallizing.

In select variations, the backing 20 may include a phenolic and urethane based moisture impermeable, electrically insulating layer comprising calcium carbonate. In one variation, the backing 20 may be deposited onto a substrate or layer by methods familiar in the art, such as, but not limited to, spraying, painting, coating, thin-film deposition, thermal spraying, or vapor deposition.

In select variations, the plurality of layers may be constructed and arranged to enhance the appearance of a decoration layer and a metallized layer, as well as to enhance the appearance of the display emblem as a whole. Additionally, the plurality of layers may be constructed and arranged to create a seal around the metallized layer to protect the metallized layer from galvanic and chemical corrosion due to environmental exposure. Additionally, the lens layer and adhesion layer may be constructed and arranged to create a seal around the decoration layer to protect the decoration layer from galvanic and chemical corrosion due to environmental exposure.

In one variation, a display emblem may function as brand designation badge on the exterior of a vehicle. The display emblem may include a plurality of layers, the plurality of layers may comprise a backing, a metallized layer, an adhesion layer, a decoration layer. and a lens layer. The backing may include a first surface and a second surface. The metallized layer may comprise metallic elements and may have a first surface and a second surface, the first surface overlying the second surface of the backing. The adhesion layer may have a first and second surface, the first surface may overly the second surface of the metallized layer. The decoration layer may have a first and second surface, the first surface may overly the second surface of the adhesion layer. The lens layer may have a first and second surface, the first surface may overly the second surface of the decoration layer. In this way, a plurality of layers may make up a display emblem.

In another variation, the backing and/or the adhesion layer may be moisture impermeable and electrically insulating.

In another variation, the adhesion layer and/or the lens layer may be moisture impermeable and electrically insulating.

In another variation, the backing and/or the adhesion layer may be moisture impermeable.

In another variation, the adhesion layer and/or the lens layer may be moisture impermeable.

In one variation, the adhesion layer and/or the decoration layer may be non-continuous.

In yet another variation, the adhesion layer and backing may be constructed and arranged to create a seal around the metallized layer to prevent exposure of the metallized layer to the environment as well as moisture, thereby reducing the risk of galvanic and chemical corrosion to the metallized layer.

In another variation, the lens layer and adhesion layer may be constructed and arranged to create a seal around the decoration layer to prevent exposure of the decoration layer to the environment as well as moisture, thereby reducing the risk of galvanic and chemical corrosion to the decoration layer.

In another variation, the lens may include a transparent or translucent polycarbonate polymer constructed and arranged to allow portions of the decoration layer and the metallized layer to be seen, yet remain impermeable to moisture. In this way, a plurality of combined layers may make up a corrosion resistant display emblem.

In one variation, the metallized layer may include indium.

In yet another variation, the decoration layer may include colored paints or pigments; the colored paints or pigments may comprise metallic and non-metallic elements.

In another variation, the metallized layer may include a metallic element such as indium. In one variation, the decoration layer may comprise colored paints or pigments, the colored paints or pigments may comprise nonmetallic or metallic elements, the metallic elements being different from the metallic element within the metallized layer.

In another variation, the adhesion layer and backing may be constructed and arranged to create a seal around the metallized layer to protect the metallized layer from exposure to moisture and the outside environment. Additionally, the lens layer and adhesion layer may be constructed and arranged to create a seal around the decoration layer to protect the decoration layer from exposure to moisture and the outside environment. A plurality of layers including a lens layer, a decoration layer, an adhesion layer, a metallized layer, and a backing may be constructed and arranged to create a moisture impermeable, electrically insulating seal around both the metallized layer and the decoration layer to protect both the metallized layer and the decoration layer from exposure to the environment and moisture.

In another variation, the decoration layer and the metallized layer may be independently and impermeably sealed from moisture. In one variation, the decoration layer and the metallized layer may also be separately and independently electrically insulated.

In another variation, the display emblem may be affixed to an underlying substrate or surface such as, but not limited to, a part, a component, or the exterior or interior of a vehicle, such as, but not limited to, a truck or an automobile.

In yet another variation, the display emblem may be affixed to an automobile grill, fascia, or body panel.

In one variation, a method of preventing galvanic and chemical corrosion within a display emblem may include providing a radar transparent display emblem which may function as a designation badge on the exterior of a vehicle. In one variation, the method may include providing a lens layer which may comprise a translucent polycarbonate. One variation may include providing a decoration layer deposited over the lens layer, the decoration layer may include colored paints or pigments containing metallic elements, and wherein deposition of the decoration layer may be accomplished through methods such as, but not limited to, spraying, coating, painting, thermal spraying, vapor deposition, or the like. One variation may include providing an adhesion layer deposited over the decoration layer, wherein the adhesion layer may be constructed and ranged to facilitate adhesion of the decoration layer and a metallized layer, and wherein deposition of the adhesion layer may be accomplished through methods such as, but not limited to, spraying, coating, painting, thermal spraying, vapor deposition, or the like. One variation may include providing a metallized layer deposited over the adhesion layer, and wherein deposition of the metallized layer may be accomplished through methods such as, but not limited to, spraying, coating, painting, thermal spraying, vapor deposition, electroplating, electro-less plating, thin film deposition, metallization, or the like. One variation may include providing a backing deposited over the metallized layer, and wherein deposition of the backing may be accomplished through methods such as, but not limited to, spraying, coating, painting, thermal spraying, vapor deposition, or the like.

In yet another variation, a method of preventing galvanic and chemical corrosion may include providing an adhesion layer and a backing which may be constructed and arranged to create a moisture impermeable seal around the metallized layer.

In another variation, a method of preventing galvanic and chemical corrosion may include providing a lens layer and an adhesion layer which may be constructed and arranged to create a moisture impermeable seal around the decoration layer.

In one variation, a method of preventing galvanic and chemical corrosion may include providing a metallized layer; the metallized layer may comprise indium.

In one variation, the adhesion layer may include a non-continuous moisture impermeable and electrically insulating layer, having a thickness ranging from about 5 micrometers or thicker.

In yet another variation, a method of preventing galvanic and chemical corrosion may include providing a decoration layer which may include colored paint or pigment, the colored paint or pigment may further include metallic elements and/or non-metallic elements.

In another variation, a method of preventing galvanic and chemical corrosion may include providing a decoration layer and a metallized layer; the metallized layer may include metallic elements including indium. In one variation, the decoration layer may including colored paint or pigment, the colored paint or pigment further including metallic elements.

In another variation, a method of preventing galvanic and chemical corrosion may include providing a decoration layer and a metallized layer; the metallized layer may include indium. In one variation, the decoration layer may include colored paint or pigment, and metallic elements differing from the metallic elements within the metallized layer.

In another variation, a method of preventing galvanic and chemical corrosion may include providing a plurality of layers; the plurality of layers including a backing, a metallized layer, an adhesion layer, a decoration layers, and a lens layer. In one variation, the adhesion layer and backing may be constructed and arranged to create a seal around the metallized layer to protect the metallized layer from environmental exposure. In one variation, the lens layer and adhesion layer may be constructed and arranged to create a seal around the decoration layer to protect the decoration layer from environmental exposure. In one variation, the plurality of layers may be constructed and arranged to create an impermeable electrically insulating seal around both the metallized layer and the decoration layer to protect both the metallized layer and the decoration layer from exposure to moisture and the environment, and potentially galvanic and chemical corrosion.

In another variation, a method of preventing galvanic and chemical corrosion may include providing a decoration layer and the metallized layer which may be independently and impermeably sealed from moisture. In one variation, the decoration layer and the metallized layer may also be separately and independently electrically insulated.

When the terms “over”, “overlying”, “overlies”, or “under”, “underlying”, “underlies” are used with respect to the relative position of a first component or layer with respect to a second component or layer, such shall mean that the first component or layer is in direct contact with the second component or layer, or that additional layers or components are interposed between the first component or layer and the second component or layer.

The above description of variations of the invention is merely illustrative in nature and, thus, variations thereof are not to be regarded as a departure from the spirit and scope of the invention.

What is claimed is:

1. A product comprising
a display emblem comprising a plurality of the layers;
the plurality of layers comprising a backing, a metallized layer, an adhesion layer, a decoration layer, and a lens layer;
the backing comprising a first and second surface;
the metallized layer comprising metallic elements and a first and second surface, the first surface overlying the second surface of the backing;
the adhesion layer comprising a first and second surface, the first surface overlying the second surface of the metallized layer;
the decoration layer comprising a first and second surface, the first surface overlying the second surface of the adhesion layer, and
the lens layer comprising a first and second surface, the first surface overlying the second surface of the decoration layer.

2. A product as set forth in claim 1, wherein the backing and the adhesion layer are moisture impermeable.

3. A product as set forth in claim 1, wherein the adhesion layer and the decoration layer are non-continuous.

4. A product as set forth in claim 1, wherein the adhesion layer and backing are constructed and arranged to impermeably encapsulate the metallized layer.

5. A product as set forth in claim 1, wherein lens layer and adhesion layer are constructed and arranged to impermeably encapsulate the decoration layer.

6. A product as set forth in claim 1, wherein the lens comprises a transparent polycarbonate polymer constructed and arranged to allow portions of the decoration layer and the metallized layer to be seen.

7. A product as set forth in claim 1, wherein the metallized layer comprises indium.

8. A product as set forth in claim 1, wherein the adhesion layer has a thickness ranging from about 5 micrometers to about 7 micrometers.

9. A product as set forth in claim 7, wherein
the decoration layer comprises colored paints or pigments, and
the colored paints or pigments comprising metallic elements differing from the metallic elements of the metallized layer.

10. A product as set forth in claim 1, wherein
the adhesion layer and backing are constructed and arranged to impermeably encapsulate the metallized layer to prevent exposure of the metallized layer to moisture;
the lens layer and adhesion layer are constructed and arranged to impermeably encapsulate the decoration layer to prevent exposure of the decoration layer to moisture, and
the decoration layer and the metallized layer are separately and independently and impermeably sealed from moisture and separately and independently electrically insulated.

11. A product as set forth in claim 9, wherein the display emblem may be affixed to an underlying substrate or surface such as an automobile part or component.

12. A method comprising:
providing a lens layer;
depositing a decoration layer over the lens layer, the decoration layer comprising colored paints or pigments containing metallic elements;
depositing an adhesion layer over the decoration layer, the adhesion layer constructed and ranged to facilitate adhesion of the decoration layer and a metallized layer;
depositing a metallized layer over the adhesion layer; and
depositing a backing over the metallized layer.

13. The method as set forth in claim 11, wherein
the backing and the adhesion layer are moisture impermeable and electrically insulating, and wherein the adhesion layer and backing are constructed and arranged to impermeably encapsulate the metallized layer.

14. The method as set forth in claim 11, wherein lens layer and adhesion layer are constructed and arranged to impermeably encapsulate the decoration layer.

15. The method as set forth in claim 11, wherein the lens comprises a transparent polycarbonate polymer constructed and arranged to allow portions of the decoration layer and the metallized layer to be seen.

16. The method as set forth in claim 11, wherein the metallized layer comprises indium.

17. The method as set forth in claim 15, wherein
the decoration layer comprises colored paints or pigments; and
the colored paints or pigments comprise metallic elements differing from the metallic elements of the metallized layer.

18. The method as set forth in claim 11, wherein
the adhesion layer and backing are constructed and arranged to impermeably encapsulate the metallized layer to prevent exposure of the metallized layer to moisture;
the lens layer and adhesion layer are constructed and arranged to impermeably encapsulate the decoration layer to prevent exposure of the decoration layer to moisture; and
the decoration layer and the metallized layer are separately and independently and impermeably sealed from moisture and separately and independently electrically insulated.

19. The method as set forth in claim 11, wherein the display emblem may be affixed to an underlying substrate or surface such as an automobile part or component.

20. A product comprising
a display emblem comprising a plurality of the layers;
the plurality of layers comprising a backing, a metallized layer, an adhesion layer, a decoration layer, and a lens layer;
the backing comprising a first and second surface, the backing being moisture impermeable and electrically insulating;
the metallized layer comprising indium and a first and second surface, the first surface overlying the second surface of the backing;
the adhesion layer comprising a first and second surface, the first surface overlying the second surface of the metallized layer, the adhesion layer having a thickness ranging from about 5 micrometers to about 7 micrometers;
the adhesion layer and backing being constructed and arranged to create a seal around the metallized layer to prevent exposure of the metallized layer to moisture;
the decoration layer comprising a first and second surface, the first surface overlying the second surface of the adhesion layer;
the lens layer comprising a first and second surface, the first surface overlying the second surface of the decoration layer;
the lens layer and adhesion layer being constructed and arranged to create a seal around the decoration layer to prevent exposure of the decoration layer to moisture, and
the decoration layer and the metallized layer being separately and independently and impermeably sealed from moisture and separately and independently electrically insulated.

21. A product comprising
a display emblem comprising a plurality of layers comprising a lens, a decoration layer, a metallized layer, and a moisture impermeable material encapsulating at least one of the decoration layer or the metallized layer.
